(19) United States
(12) Patent Application Publication
(10) Pub. No.: US 2010/0000486 A1
(43) Pub. Date: Jan. 7, 2010

(54) IGNITION DEVICE FOR AN INTERNAL COMBUSTION ENGINE

(76) Inventors: Werner Herden, Gerlingen (DE); Manfred Vogel, Ditzingen (DE); Heiko Ridderbusch, Schwieberdingen (DE)

Correspondence Address: KENYON & KENYON LLP, ONE BROADWAY, NEW YORK, NY, 10004, US

(21) Appl. No.: 12/301,144

(22) PCT Filed: Apr. 23, 2007
(86) PCT No.: PCT/EP2007/053924

§ 371 Date: May 11, 2009

(30) Foreign Application Priority Data
May 26, 2006 (DE) 102006024679.9

(51) Int. Cl. F02B 19/00; H01S 3/091; F02P 23/04

(52) U.S. Cl. 123/143 B; 372/70; 359/333

(57) ABSTRACT

An ignition device for an internal combustion engine, in particular of a motor vehicle, includes at least one pump light source, which provides a pump light. Furthermore, a laser device is provided, which is able to generate a laser light for beaming into a combustion chamber. A waveguide device transmits the pump light from the pump light source to the laser device. The laser device includes at least one refraction device, for example, a lens, which refracts the pump light and is in one piece therewith.

### FIELD OF THE INVENTION

The present invention relates to an ignition device for an internal combustion engine.

### BACKGROUND INFORMATION

WO 02/081904 describes a generic ignition device, which is designed as a laser ignition device and is situated on a cylinder of an internal combustion engine. The actual laser device is connected to a pump light source, which optically pumps the laser device, via a waveguide device formed by fiberglass.

### SUMMARY

Example embodiments of the present invention provide an ignition device of the above-named type in such as to provide it to be mass-produced and used in the most economical possible manner.

Features of example embodiments of the present invention are also provided in the description that follows and the drawings; the features may also be provided in example embodiments of the present invention in completely different combinations without explicit reference being made thereto.

The refraction device provided according to example embodiments of the present invention may be manufactured very economically, for example, as an injection-molded part. A complex surface treatment which, for example, would be necessary for a reflector device may be omitted. The manufacturing costs for the ignition device according to example embodiments of the present invention are thus reduced. The single-part design of the refraction device according to example embodiments of the present invention having the laser device also results in simpler handling when the ignition device is installed in the internal combustion engine because the position of the refraction device within the laser device, which is important for the operation of the ignition device, is not modified despite the external forces acting thereon, but is reliably and accurately ensured. In addition, fewer separate parts are to be handled, which also reduces assembly costs and assembly times.

A first advantageous refinement of the ignition device according to example embodiments of the present invention is characterized by the fact that the laser device includes a laser-active solid and the refraction device includes a lens which is situated on the injection side of the laser-active solid. The pump light refracted by the refraction device may thus be easily injected, mainly transversally, into the laser-active solid. Of course, if the lens is attached directly to the injection side of the laser-active solid, the attachment area on the lens is polished flat to avoid refraction of the pump light arriving in the laser-active solid longitudinally.

The refraction device may, however, also include a lens which is situated between the laser-active solid and an optical amplifier. The laser-active solid is thus pumped only longitudinally or at least less transversally, whereas the optical amplifier is pumped at least also transversally.

The refraction device may also include a lens which has an opening and is situated radially outside the laser-active solid. This offers the advantage, mainly when an optical amplifier is provided in series with the laser-active solid, that the laser light transmitted from the laser-active solid to the amplifier is not absorbed by the lens, i.e., the efficiency of the overall ignition device is relatively high.

Another advantageous embodiment of the ignition device according to example embodiments of the present invention provides that a reflection device be provided, which reflects the pump light refracted by the refraction device to the laser-active solid and/or to the optical amplifier. This increases the degrees of freedom in the design of the ignition device. In particular it makes it possible to use the light refracted by the refraction device for longitudinal pumping of the laser-active solid and/or the optical amplifier.

A relatively “slim” ignition device is created if the reflection device is situated coaxially with respect to the laser-active solid and/or to the optical amplifier and is at least substantially transparent to laser light. The efficiency is further improved if the reflection device is coaxial with respect to the laser-active solid and/or to the optical amplifier and has an opening through which the laser light may pass because in this case absorption of the laser light by the reflection device is prevented.

It is advantageous if the laser device, including the laser-active solid, injection mirror, extraction mirror, Q-switch, amplifier, and lens are an overall single piece, optimally forming a monolithic component.

Example embodiments of the present invention are described below in greater detail with reference to the appended drawing.

### BRIEF DESCRIPTION OF THE DRAWINGS

FIG. 1 schematically shows an internal combustion engine having an ignition device;

FIG. 2 schematically shows the ignition device of FIG. 1;

FIGS. 3 through 8 schematically show different example embodiments of the ignition device of FIG. 2.

### DETAILED DESCRIPTION

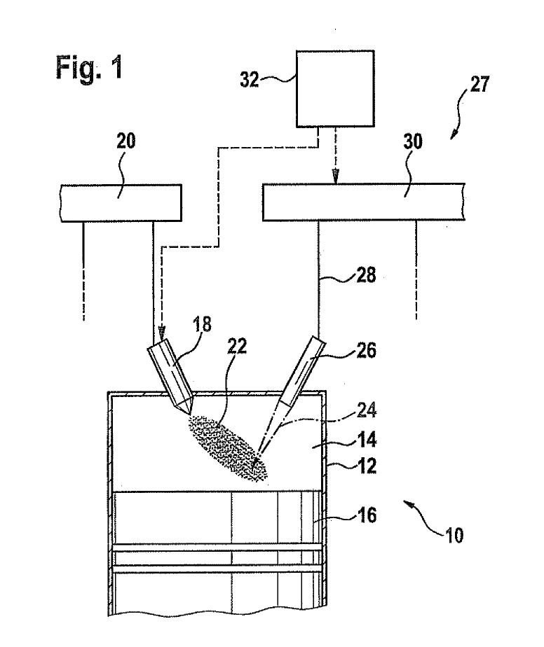

An internal combustion engine is labeled overall with reference numeral 10 in FIG. 1. It is used for driving a motor vehicle. Internal combustion engine 10 includes a plurality of cylinders, only one of which is depicted and labeled with reference numeral 12 in FIG. 1. A combustion chamber 14 of cylinder 12 is delimited by a piston 16. Fuel reaches combustion chamber 14 directly through an injector 18, which is connected to a pressurized fuel reservoir (“rail”) 20.

Fuel 22 injected into combustion chamber 14 is ignited with the help of a laser beam or laser pulse 24, which is beamed into combustion chamber 14 by an ignition device 27 including a laser device 26. For this purpose, laser device 26 is supplied with pump light, which is provided by a pump light source 30, via a waveguide device 28. Pump light source 30 is controlled by a control and regulating unit 32, which also activates injector 18.

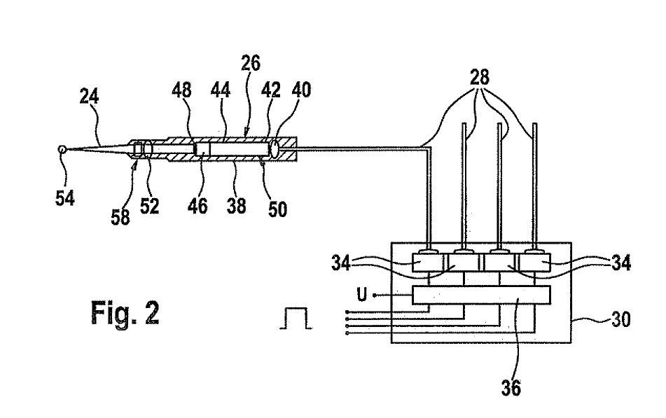

As is apparent from FIG. 2, pump light source 30 supplies a plurality of waveguide devices 28 for different laser devices 26. For this purpose, it has a plurality of individual light sources 34, which are connected to a pulse current supply 36.

Laser device 26 includes a housing 38, in which, viewed in the direction of the pump light, first a lens 40 forming a refraction device, then an injection mirror 42, and further a laser-active solid 44, a passive Q switch 46, and an extraction mirror 48 are situated. Elements 40 through 48 are designed overall as a single-piece or monolithic component 50.

In FIG. 2, left of extraction mirror 48, there is a focusing optical device 52, which focuses laser beam 24 on a desired point 54. Furthermore, laser device 26 has a combustion chamber window 56, which seals housing 38 pressure-tight against combustion chamber 14.

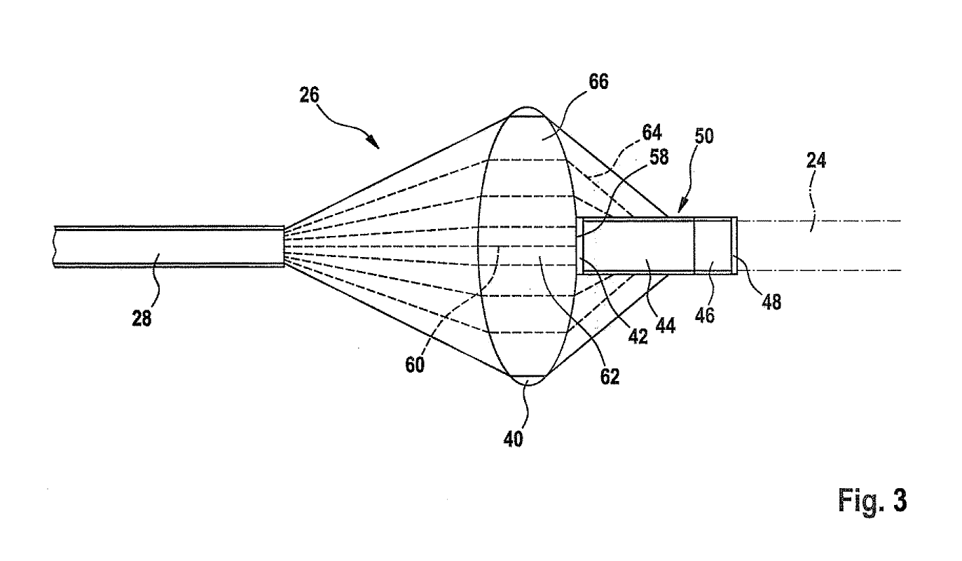

Optical components of laser device 26 are depicted in FIG. 3 in bolder lines, the sides being reversed with respect to FIG. 2. It is apparent that the outer diameter of lens 40 is significantly greater than the outer diameter of laser-active solid 44. Lens 40 is fixedly connected to injection mirror 42, for example, wrung together or bonded. This creates an overall single-piece monolithic unit 50, which also includes lens 40.

The boundary surface (reference numeral 58 in FIG. 3) connected to injection mirror 42 is polished or ground flat having a surface planarity <X/4 (X =wavelength), so that the pump light beams (reference numeral 60 in FIG. 3) introduced from lens 40 into injection mirror 42 and further into laser-active solid 44 reach laser-active solid 44 essentially without further refraction. As a variant, a central hole may also be provided in lens 40. FIG. 3 shows that, on the one hand, laser-active solid 44 is pumped longitudinally with pump light 60, which passes through a central area 62 of lens 40 largely without refraction, and that laser-active solid 44, on the other hand, is pumped transversally with pump light 64, which is refracted in a radially outer edge area 66 of lens 40 toward laser-active solid 44.

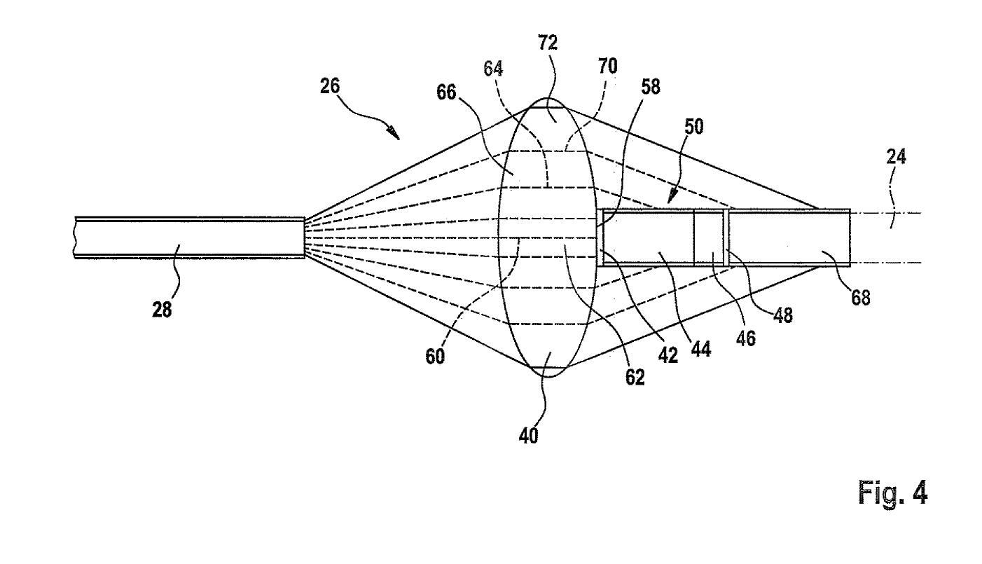

Further example embodiments of the optical components of laser device 26 are shown in greater detail in FIGS. 4 through 8 that follow. Here and in the following, elements and areas having the same or similar functions as elements and areas of a previously described example embodiment bear the same reference numeral and are not elucidated in detail again.

The example embodiment shown in FIG. 4 differs from the one shown in FIG. 3 in that the former has an additional optical amplifier 68 which is molded onto extraction mirror 48 in one piece. Optical amplifier 68 is, on the one hand, pumped longitudinally by pump light 60, which is not absorbed by laser-active solid 44. In addition it is, however, transversally pumped by pump light 70 which is refracted, in an edge area 72 of lens 40 located radially far out, toward optical amplifier 68. Using an appropriate design of lens 40 the ratio of pump light 60 and 64, which is injected into laser-active solid 44, to pump light 70, which is injected into amplifier 68, may be set in a simple manner in this example embodiment.

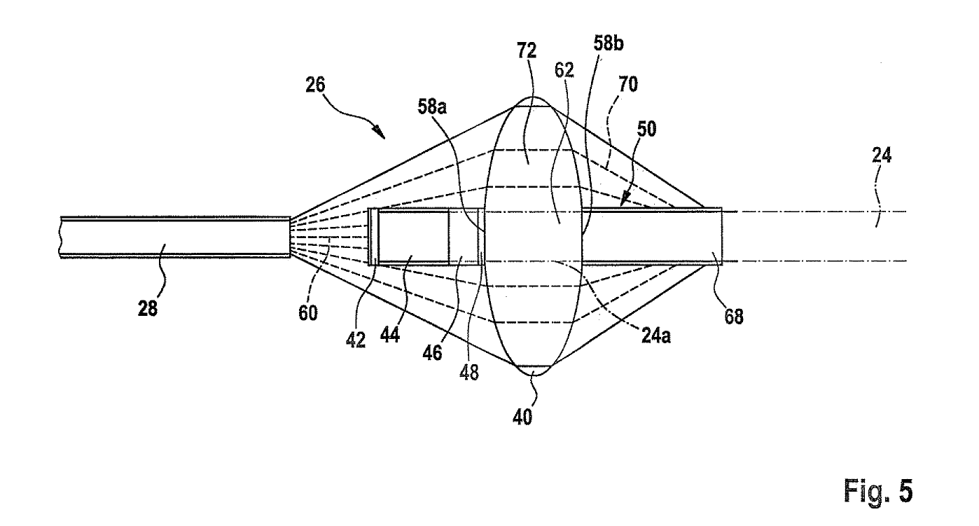

The example embodiment depicted in FIG. 5 of the essential optical components of laser device 26 in turn differs from that of FIG. 4 by the fact that lens 40 is situated between laser-active solid 44 having injection mirror 42, Q-switch 46, and extraction mirror 48 on the one hand and amplifier 68 on the other hand. Laser light 24a generated in laser-active solid 44 thus passes through lens 40 to reach amplifier 68. Laser-active solid 44 is also pumped, exclusively longitudinally, by pump light 60 exiting from waveguide device 28; lens 40 is thus used exclusively for refracting pump light 70 in radially outer edge area 72 toward optical amplifier 68 and thus pumping the latter transversally.

Also in this case, an overall single-piece or monolithic component 50 is created by molding extraction mirror 48 on one side of lens 40 and optical amplifier 68 on the other side of lens 40 in one piece, for example, wrung together or bonded. For this purpose, again, the corresponding contact surfaces 58a and 58b of lens 40 are polished or ground flat, so that laser light 24a extracted from extraction mirror 48 reaches optical amplifier 68 unrefracted. Also in this example embodiment, the optical ratios may be set in a simple manner and with high accuracy by dimensioning the individual components.

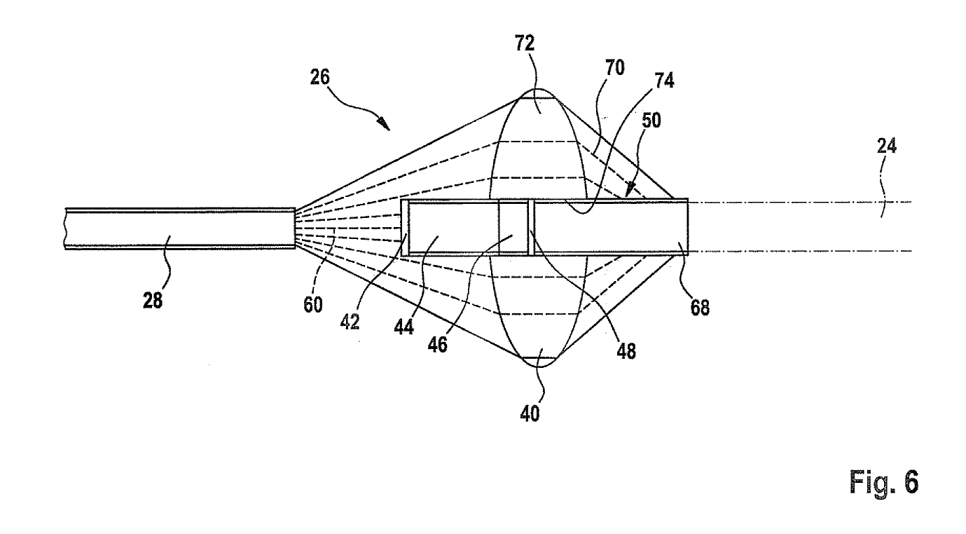

In the example embodiment shown in FIG. 6, similar to that of FIG. 4, optical amplifier 68 is situated directly on extraction mirror 48 on laser-active solid 44. Lens 40 has a central opening 74, into which the unit made up of laser-active solid 44 and optical amplifier 68 is inserted. Also in this case, an overall single-piece unit 50 may be created by puttying or gluing together single-piece part 50 made up of laser-active solid 44 and optical amplifier 68 with lens 40. The example embodiment shown in FIG. 6 differs from that of FIG. 5 by increased efficiency because the laser light produced by laser-active solid 44 reaches optical amplifier 68 directly and does not need to pass through lens 40.

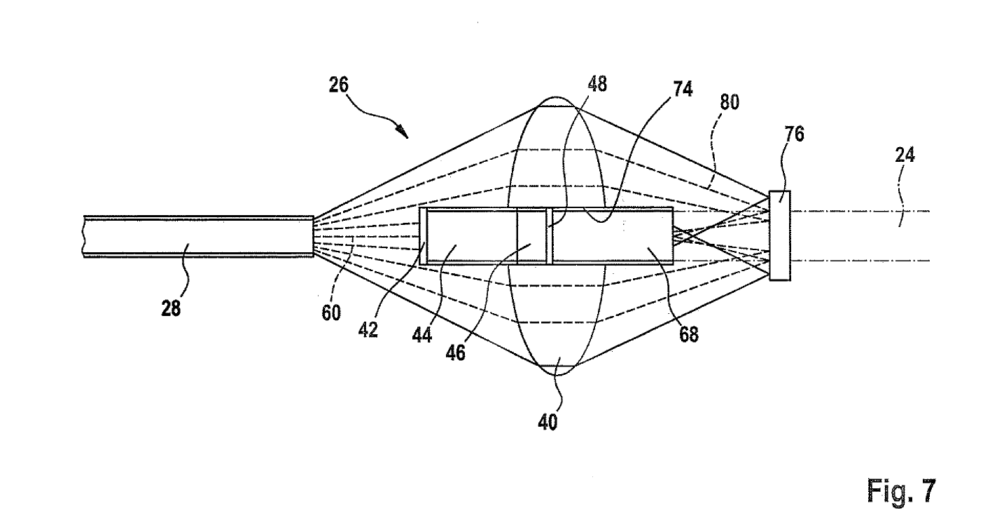

The example embodiment shown in FIG. 7 has a design similar to that of FIG. 6. However, it also includes a reflection device 76 which in FIG. 7 is situated to the right of optical amplifier 68 in the axis of laser light beam 24 exiting therefrom. Reflection device 76 is at least essentially transparent to laser light 24 but essentially reflecting for pump light 80 refracted by lens 40. Lens 40 is designed in such a way that it does not refract pump light 80 or at least does not refract it transversally to optical amplifier 68, but to reflection device 76, which pumps pump light 80 longitudinally into optical amplifier 68. It is understood that the basic system shown in FIG. 7 could also be combined with those of FIGS. 4 and 5.

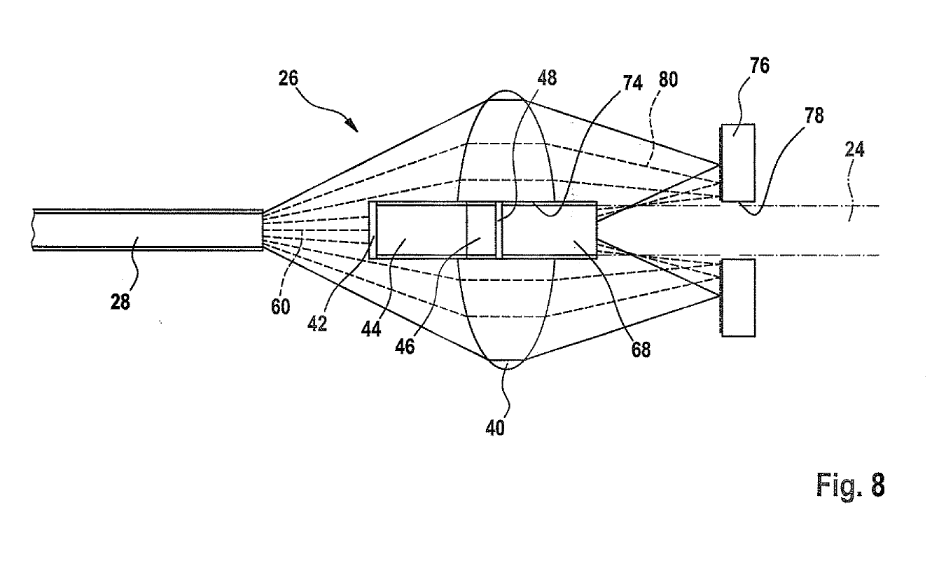

The example embodiment of a laser device 26 shown in FIG. 8 is again based on that of FIG. 7. The only difference is that reflection device 76 of the example embodiment of Figure 8 has a central opening 78, through which laser light 24 emitted by optical amplifier 68 may pass. This has the advantage that reflection device 76 may be provided with a higher efficiency, i.e., higher reflection, and at the same residual absorption of laser light 24 in reflection device 76 is ruled out.

The reflector (no reference numeral) of reflection devices 76 of FIGS. 7 and 8 is flat. However, it may also be curved, so that reflection devices 76 would also have a focusing function.

1 to 12. (canceled)

13. An ignition device for an internal combustion engine, comprising:
at least one pump light source adapted to provide a pump light;
a laser device adapted to generate a laser light to be beamed into a combustion chamber; and
a waveguide device adapted to transmit the pump light from the pump light source to the laser device;
wherein the laser device includes at least one refraction device adapted to refract at least a portion of the pump light and is in one piece with the pump light.

14. The ignition device according to claim 13, wherein the internal combustion engine is an internal combustion engine for a motor vehicle.

15. The ignition device according to claim 13, wherein the laser device includes a laser-active solid and the refraction device includes a lens arranged on an injection side of the laser-active solid.

16. The ignition device according to claim 15, wherein the refraction device includes a lens arranged between the laser-active solid and an optical amplifier.

17. The ignition device according to claim 15, wherein the refraction device includes a lens arranged radially outside of at least one of (a) the laser-active solid and (b) an amplifier.

18. The ignition device according to claim 15, wherein the refraction device is adapted to refract the pump light toward the laser-active solid to at least partially pump the laser-active solid transversally.

19. The ignition device according to claim 15, wherein the lens is adapted to refract the pump light toward an optical amplifier to at least partially pump the optical amplifier transversally.

20. The ignition device according to claim 13, wherein the laser device includes a reflection device adapted to reflect the pump light refracted by the refraction device toward at least one of (a) a laser-active solid and (b) an optical amplifier.

21. The ignition device according to claim 20, wherein the reflection device is situated coaxially with respect to at least one of (a) the laser-active solid and (b) the optical amplifier and is at least substantially transparent to laser light.

22. The ignition device according to claim 20, wherein the reflection device is situated coaxially with respect to at least one of (a) the laser-active solid and (b) the optical amplifier and has an opening through which the laser light is passable.

23. The ignition device according to claim 20, wherein the reflection device is adapted to reflect the pump light such that at least one of (a) the laser-active solid and (b) the optical amplifier are at least also pumped longitudinally.

24. The ignition device according to claim 13, wherein the laser device forms an overall one-piece component.

25. The ignition device according to claim 15, wherein the lens is an injection molded part.
